(19) United States
(12) Patent Application Publication
(10) Pub. No.: US 2015/0180920 A1
(43) Pub. Date: Jun. 25, 2015

(54) METHODS AND SYSTEMS FOR SECURE DATA COMMUNICATION AND SYSTEM MONITORING

(71) Applicant: ROBERT HUNTER, SAN RAMON, CA (US)

(72) Inventor: ROBERT HUNTER, SAN RAMON, CA (US)

(21) Appl. No.: 14/135,342

(22) Filed: Dec. 19, 2013

(51) Int. Cl. H04L 29/06; H04W 4/10; H04L 29/08

(52) U.S. Cl. CPC H04L 65/4061; H04L 67/025; H04W 4/10; H04L 63/0272

(57) ABSTRACT

The present invention provides methods of and systems for secure data communication and system monitoring. In accordance with an embodiment of the present invention, a system includes at least one monitored device, at least one data-gathering client, at least one server and at least one end-user client. Data is generated with respect to a task performed by the monitored device. The data-gathering client obtains the data from the monitored device via a secure private network. In response to the data, the data-gathering client opens a secure push-communications connection between itself and the server and transfers data to the server. In response to this data, the server opens a push-communications connection between itself and, ultimately, the end-user client. The end-user client displays data received from the server wherein the displayed data is derived from the data generated with respect to a task performed by the monitored device.

This application claims the benefit of U.S. Provisional Application No. 61/740,341, filed Dec. 20, 2012, and the benefit of U.S. Provisional Application No. 61/771,422, filed Mar. 1, 2013, the entire contents of both of which are hereby incorporated by reference.

### FIELD OF THE INVENTION

The present invention relates to secure data communication and to system monitoring. More particularly, the present invention relates to using multiple instances of push communication technology in a secure monitoring or management system with notification options.

### BACKGROUND OF THE INVENTION

The field of Internet-based communications is constantly changing and evolving. Traditionally, local computers were used to communicate with remote servers using a browser, which would display text, graphics and other information on the local screen. In a typical Internet application, a browser-based client would request information that resides on a remote server and the server would respond with its information. This transaction would normally take place on an open, unsecure port that is not blocked by any firewall or other restrictions. This represents a typical request/response transaction in a client-server network.

While this client-server based topology works well for traditional browser-based data display, it suffered from many shortcomings. One such shortcoming became clear when attempting to communicate from a client to a server where that client did not have the use of a browser. One such application was the use of remote facilities monitoring devices that gathered data from facilities infrastructure or other devices and needed to feed that data to a remote central server for processing. In such a case, the data-gathering device normally did not include a browser and, sites were normally equipped with a firewall to prevent any non-browser based communication and/or non-standard communication port communication from taking place. A technology known as “push communication” or “push technology” began around such applications in the 1990s. This contrasted with the request/response technology as the initiator of this network transaction was pushing information and not expecting a response per-se′. One such example of this is Hunter in U.S. Pat. No. 6,363,422, which discloses the use of push communications to send information with respect to infrastructure devices from a client to a server through a firewall or other infrastructure.

In the case of Hunter, the client sends a keep-alive message or a full data set from a client device that is monitoring one or more pieces of facilities equipment. Hunter employed a client that used standard ports with Internet Protocol (IP) communications thus enabling its data to be sent through a firewall. In the early days of the Internet, bandwidth use was extremely expensive so, care was taken to send larger amounts of data only when necessary. Thus, Hunter employed push technology to attempt to safely pass through a firewall and moderate the use of bandwidth by keeping data local and using bandwidth only for keep-alive or emergency alarm transmission. Following this early growth of client-to-server push technology, the web evolved into a much lower-cost-of-bandwidth medium and firewalls for non-browser devices became more accommodating. However, new security and other concerns have grown considerably and have not been well addressed by existing client/server and other technologies.

The phrase “push technology” as it was used in connection with client to server push communications in Hunter has evolved and “push technology” later reemerged with a completely different meaning. In a Web 2.0 context, push technology refers to a server that is pushing data to large numbers of mobile and other devices with continuous or near continuous information streams. Thus, the phrase “push technology” has taken on an entirely new meaning. As Wikipedia now defines it: “Push, or server push, describes a style of Internet-based communication where the request for a given transaction is initiated by the publisher or central server.” That is, in Web 2.0 parlance, “server-push” technology involves initiating a data transaction between client and server whereby the server pushes data to one or more clients. Fortunately, by making the distinguishing reference with the word “server” before the word “push,” the indication is made that this is not the same as the original client-push technology.

A number of technologies have now emerged that employ server push technology for streaming of live and near-live data. These include Extensible Messaging and Presence Protocol (XMPP), which is a server push technology based on Extensible Markup Language (XML) protocol as well as Bidirectional streams Over Synchronous HPPT (BOSH), which is a two-way communication that may be initiated by a server push, and many others are presently evolving. In addition, other mainstream protocols such as Simple Object Access Protocol (SOAP) have been adapted for server push technology.

Now, with the advent of such new protocols, languages and architectures, web users have begun to revisit client-push architectures. In one such example, Hansen shows use of XML and related technologies in a client-push environment in U.S. Pat. No. 6,757,714. In Hansen, architecture similar to Hunter is disclosed. The system of Hansen is meant to detect a state change of a device and to relay information about that state change, just as Hunter did. In the case of Hansen, XML or even e-mail, which is a simple push technology from a client to server, is used. It should be pointed out, however, that the final transport of e-mail is a typical request/response transaction via a client-server architecture whereby a computer requests whether any new e-mail has been received and the e-mail server responds by sending any new e-mail that it has received.

Hansen in U.S. Pat. No. 7,082,460 discloses another scheme that includes control capabilities for a remote or local system using push technology. Hansen, in another invention, U.S. Pat. No. 8,060,886; discloses Simple Object Access Protocol (SOAP) as a means to push data from client to server. In yet another version of client-push technology, Ransom in U.S. Pat. No. 6,990,395 uses a system of push technology that adds protocols including Hyper Text Transfer Protocol (HTTP), File Transfer Protocol (FTP), telnet or Network News Transfer Protocol (NNTP) in addition to XML in order to provide information about local power conditions to a central location so as to enable better power management.

While these technologies have sought to advance push technology in one way or the other, client-push technology is still a relatively little used technology. One significant reason for this is the lack of security in the communications of such systems. The languages and protocols employed by Hanson and Ransom of XML, SOAP, HTTP, FTP, telnet and others are either wholly without any security or offer only limited security. Thus, important data could be intercepted by others and used in a manner that compromises the integrity of the data users. Biron in U.S. Application Number 20120131473 suggests the use of security technology in a push application using a vague Java-based push technology through the use of a scripting language. However, Biron does not teach in any manner how someone skilled in the art could make such an implementation. In addition, a number of significant security flaws have been discovered within Java and various governmental and other organizations are now restricting its use within their environments. Thus, it would not be a good choice to solve the security problems that have plagued client-server based push technology.

Furst, in U.S. Patent Publication Number 20120092727, does suggest the use of various types of security in a push technology scheme through encryption using VeriSign certificates, RSA encryption or Secure Socket Layer (SSL) security. However, Furst employs XML and other languages that have caused security concerns for data that is acquired. The issue of security is especially a concern when dealing with the monitoring of data for mission critical infrastructure in a data center where Statement on Standards for Attestation Engagements No. 16 (SSAE 16) requirements. Security is also a major concern in healthcare facilities where Health Insurance Portability and Accountability Act (HPPA) requirements come into play. In addition, security concerns within individual corporate facilities are a rising concern when these facilities are subject to reporting under the Sarbanes-Oxley Act or the Dodd-Frank Act. In sum, data centers, health care facilities, corporate facilities as well as government facilities have the need for a high level of security for data transactions and the lack of security in client-push based technologies has hampered deployment of high quality equipment monitoring systems.

Another area that has not been addressed by existing client-push technologies is the area of data overhead and transmission time latency. As many of these existing technologies rely on older protocols such as HTTP and others, such protocols add significant overhead to each data transmission and thereby create latency in data transfer. In mission critical applications, such as life safety and other critical applications, even small delays in the passing of important data can be extremely significant. In the case of a healthcare facility, for example, a delay in passing important information could result in the loss of life or injury to one or more patients. In other facilities, such as data centers, a delay could result in the loss of millions of dollars per minute. Even in the case of an office building, a delay of critical data could mean the loss of significant revenues.

Yet another area that has not been addressed by existing client-push technology is the area of accessibility. As cloud computing comes to the forefront, a secure and robust means for pushing data to the cloud and then moving data from cloud to any mobile user in any location needs to be addressed. Without such a structure, data transmitted from the client to the cloud and from the cloud to the user could all be in jeopardy. This would virtually eliminate using current technologies in a cloud system to transport mission critical data in a client-push system where SSAE 16, HPPA, Sarbanes-Oxley, Dodd-Frank or other similar standards are in force.

### SUMMARY OF THE INVENTION

The present invention provides methods of and systems for secure data communication and system monitoring using push technology. In accordance with an embodiment of the present invention, a system includes at least one monitored device, at least one data-gathering client, at least one server and at least one end-user client. Data is generated with respect to a task performed by the monitored device. The data-gathering client obtains the data from the monitored device. In response to the data, the data-gathering client may open a push-communications connection between itself and the server and transfers data to the server. In response to this data, the server may open a push-communications connection between itself and the end-user client. The end-user client displays data received from the server wherein the displayed data is derived from the data generated with respect to a task performed by the monitored device.

### BRIEF DESCRIPTION OF THE DRAWINGS

The present invention is described with respect to particular exemplary embodiments thereof and reference is accordingly made to the drawings in which:

FIG. 1 illustrates a block schematic diagram of a system for a business or government facility in accordance with an embodiment of the present invention;

FIG. 2 illustrates a block schematic diagram of a system for a healthcare or hospital facility in accordance with an embodiment of the present invention;

FIG. 3 illustrates a block schematic diagram of a system for a residence or residential facility in accordance with an embodiment of the present invention;

FIG. 4 illustrates a more detailed block schematic diagram of a system for a residence or residential facility in accordance with an embodiment of the present invention;

FIG. 5 shows a flow chart of a method employing an infrastructure device in accordance with an embodiment of the present invention;

FIG. 6 shows a flow chart of a method employing an uninterruptable power supply in which a server computes alarm decisions in accordance with an embodiment of the present invention;

FIG. 7 shows a flow chart of a method employing an uninterruptable power supply in which a data-gathering client computes alarm decisions in accordance with an embodiment of the present invention; and

FIG. 8 shows illustrates a block schematic diagram of a system for monitoring a life support system and for delivering output to a mobile device in accordance with an embodiment of the present invention.

FIG. 9A illustrates an example of the present invention polling an infrastructure device that is a UPS system wherein an anomaly with the device is discovered.

FIG. 9B shows all of the relevant portions of FIG. 9A and illustrates the transmission of information related to an anomaly, as seen from the server to a messaging server and then to the end-user client of information.

FIG. 10 illustrates an example of the present invention poling an infrastructure device that is a UPS system where no anomaly is discovered during a polling cycle.

### DETAILED DESCRIPTION OF A PREFERRED EMBODIMENT OF THE INVENTION

In accordance with an embodiment of the present invention, a system includes at least one monitored device, at least one data-gathering client, preferably the UPShield management client from Secure Power Networks, at least one server, preferably the Secure Power Networks Server from, and at least one end-user client. Data is generated with respect to a task performed by the monitored device. The data-gathering client obtains the data from the monitored device. In response to the data, the data-gathering client may open a push-communications connection between itself and the server and transfers data to the server. In response to this data, the server may open a push-communications connection between itself and the end-user client. The end-user client displays data received from the server wherein the displayed data is derived from the data generated with respect to a task performed by the monitored device.

In a preferred embodiment, the push-communications connections are established via WebSocket connections, a secure communication channel that persists until closed. WebSocket is a communication protocol standardized by the Internet Engineering Task Force (IETF) as Request for Comments (RFC) 6455. WebSocket is a preferred protocol for such push-communication connections in view of its inherent features. Among its features is an ability to start its communication sequence as an HTTP request but then upgrade to a secure, low-latency, persistent connection. More particularly, the WebSocket Secure protocol (WSS) enables a client-originated push-based, secure, encrypted two-way communication between a network entity running code in a controlled environment to a remote host that has opted-in to receive communications from that network entity. Security is in accordance the origin-based Secure Socket Layer (SSL) security model commonly used by web browsers to transmit credit card and other sensitive data. The WebSocket protocol allows the originating push from a network entity such as a data gathering client to a host entity such as a server and involves opening a secure handshake followed by encrypted message transmission, layered over TCP. This process cuts down on cuts overhead and latency inherent in HTTP connections because the protocol provides a two-way communication mechanism between client-based applications and one or more servers that does not rely on opening multiple HTTP connections. Thus, WebSockets avoid problems of security, latency and accessibility created by HTTP and other protocols. WebSockets provide a secure, standardized way for a network entity to send content to another network entity without the sending entity being solicited by the receiving entity, and then allows for messages to be securely and expeditiously passed back and forth so long as the connection is kept open. The WebSocket Protocol published by IETF in December of 2011, describes the WebSocket communication protocol and is hereby incorporated by reference. While WebSocket is a preferred protocol and the following description refers to WebSocket for convenience, it will be understood that a different standardized protocol or a non-standardized protocol can be employed in push communications in connection with the present invention. Such a protocol can include one or more of the features of WebSockets.

To date, WebSockets are being used almost exclusively in Web 2.0 server-push technology communications. However, the present invention uses WebSockets to form a client-to-server push connection and then a server-to-client push connection wherein the originating client device communicates to a server that may reside locally or in another location and wherein the server then communicates to a receiving client that may be in either the location of the originating client, the location of the server or a completely different location. This may be viewed as two separate but related connections, (i.e. originating client-to-server and server-to-receiving client).

In the present invention, a novel method of using WebSocket has been constructed to securely establish a connection from an originating client (also referred to herein as a data-gathering client) in any location, even within a firewall, to a remote server and then to a receiving client (also referred to herein as an end-user client), for example a mobile device. Because at least two distinct but related push transactions occur in this invention, we have used the term: “multi push” technology to describe the process.

A process in accordance with an embodiment of the present invention begins from an originating client device, which we refer to as the data-gathering client, which may be located inside a firewall. The data-gathering client gathers information from one or more device(s) within a facility and culls that information using analytics such as standard deviation from the mean to determine if there are statistical anomalies present within the security or operating functions of the one or more devices. On a regular basis, for example every minute or, immediately if an anomaly is discovered by the data-gathering client, a secure WebSocket connection is opened from the data-gathering client to a server and, the data-gathering client then transmits data over a secure WebSockets connection until its entire data stream is done. The server, upon receipt of the data from the client, has a number of actions that it may take with respect to that data. It may, for example if no anomaly was detected by the data-gathering client, process the data and simply store it for the present time. It may, if an anomaly was discovered, process, store and immediately forward part or all of the data to an end-user client and, in some case even to another server. It may, as yet another alternative, store and forward the data as it is, without processing to an end-user client and/or to another server. It may, as another alternate, simply forward the data to an end-user client or another server for additional processing by that other server. For example, the data-gathering client may poll an infrastructure device every 1.5 seconds for data with respect to the health and operating conditions of that device. The data-gathering client may then process that data using statistical analysis to determine if an anomaly exists with the infrastructure device. If an anomaly is determined by such statistical analysis, the data-gathering client may then immediately open a WebSockets connection between itself and a server and the data-gathering client may then immediately transfer information with respect to the infrastructure device to the server. In such a case, the primary server may immediately forward a message to an end-user client via WebSockets or other means for display of information surrounding the anomaly event with respect to the monitored device.

In another example, the data-gathering client may poll an infrastructure device every 1.5 seconds for data with respect to the health and operating conditions of that device. The data-gathering client may then process that data using statistical analysis to determine if an anomaly exists with the infrastructure device. If no anomaly is determined to be present by such statistical analysis, the data-gathering client may then wait for a full minute before any connection is opened between itself and a server. At the end of that minute, the data-gathering client may open a WebSockets connection to the primary server and transmit data with respect to the high, low and mean for each data point queried from the infrastructure device during the past minute. The data-gathering client may also forward data on that same WebSockets connection with respect to the running mean and running standard deviation for each data point queried from the infrastructure device during the past minute. The data-gathering client may disconnect such WebSocket connection after transmission or it may leave the connection open. The data-gathering client may transmit data to the primary server at the end of every minute. The primary server may receive the data from the data-gathering client may store the data. The primary server may also forward the data to a secondary server for further statistical analysis using more sophisticated processing than may be available to the data-gathering client. If, using its further processing power, the secondary server determines that an anomaly with the infrastructure device exists, it may establish a WebSockets connection with the primary server and the primary server may establish a WebSockets connection with the end-user client. Data may then be transmitted via WebSockets from the primary server to the end-user client for display with respect to the anomaly determined by the secondary server with respect to the infrastructure device.

When forwarding data to an end-user client, such as a mobile device, care must be used to communicate with the end-user client by employing a secure, yet low power using means of communication. For example, when an end-user client is a cell-phone, a tablet computer, a smart watch, a Personal Digital Assistant (PDA) or related device, care must be taken to keep battery use of such devices to a minimum. However, if an end-user client application runs constantly with a continuous open WebSocket connection to the primary server, battery life on the end-user client could suffer. In such a case, an additional server can be used that can employ a very low bandwidth and very low power use application running on the end-user client that runs in the background of that client. In an example of such an instance, the additional server may be a Message Queue (MQ) technology cloud-based server that is built for lightweight communications such as the Apple Messaging Service, the Google Messaging Service, IBM Message Queue Telemetry Transport (MQTT) Service or another MQ technology, service or server. The Apple Messaging Service and the Google Messaging Service employ cloud server systems that offer encrypted message communications to an Apple IOS device or a Google Android device respectively. MQTT does not at this time provide a similar level of security but may provide such a level of security at another time.

As an example of a transaction involving an MQ server, the data-gathering client may poll an infrastructure device every 1.5 seconds for data with respect to the health and operating conditions of that device. The data-gathering client may then process that data using statistical analysis to determine if an anomaly exists with the infrastructure device. If an anomaly is determined by such statistical analysis, the data-gathering client may then immediately open a WebSockets connection between itself and the primary server and the data-gathering client may then immediately transfer information with respect to the infrastructure device to the primary server. In such a case, the primary server may immediately forward a message to the Apple Messaging Service cloud server system. The Apple Messaging Service cloud server system may then immediately forward the message to an IOS end-user client running on a iPad, iPhone, iWatch or other device via its own secure, encrypted messaging technology. In order to supplement the message sent by the primary server to the end-user client via the Apple Messaging Service cloud server system, the IOS-based end-user client, on receipt of the message from the Apple cloud server system, may open a secure WebSockets connection between itself and the primary server and may request live and/or historical data, including live and/or historical data graphs with respect to the infrastructure device. The primary server may then immediately send such live and/or historical data, including live or historical graphical data to the end-user client via the same secure WebSockets connection. Following such transmission from the primary server to the end-user client, the end-user client may then disconnect the WebSockets connection to save battery life.

As an example of a process in accordance with an embodiment of the present invention, a data-gathering client may be communicating with an Uninterruptible Power Supply (UPS) system through a Simple Network Management Protocol (SNMP) card or similar device located within or connected to the UPS. Such communication may take place via a private Ethernet connection between the data-gathering client and the SNMP card or other device to ensure maximum security. A private network may be a direct Ethernet cable from the data-gathering client to the UPS for maximum security of the UPS system. For UPS devices that have WiFi, Bluetooth or other wireless standards, a direct one-to-one, private and encrypted communication session may be opened between the data-gathering client and the UPS communications port. The data-gathering client may then poll the UPS via its SNMP device via the private Ethernet connection. This polling may take place every second on a continuous basis to receive information with respect to the UPS system. The data-gathering client may then continuously process the data received from the SNMP device with respect to the UPS system through statistical analysis to determine if any anomaly is present within the UPS. For example, if a data point with respect to the input voltage from the UPS unit was more than 3 standard deviations from the running mean of the previous input voltage data, that would constitute a data point that is in the range of only 0.27% of all values received for the input voltage of UPS and may be flagged as an anomaly. If an anomaly is spotted, an immediate Secure WebSocket (WSS) connection may be opened from a second Ethernet port, a public port on the data-gathering client that is placed on a company, government or other public network in order to push data to the primary server with respect to the anomaly may then be transmitted to the primary server. The second, public Ethernet port, though on a company, government or Internet connection, is secured by an internal firewall that does not allow any outside inbound connections. It may still accept inbound data from the primary server, as WebSockets are a bidirectional communication but, the data-gathering client will accept no information from a connection that it did not initiate with an initial push connection. In this way, the device may be connected to a corporate or government network or even the Internet and may still maintain security. By transmitting its data to the primary server via a WSS connection, no potential intruder should be able to sniff or otherwise decode the data sent from the data-gathering client to the primary server. The primary server may then immediately send a message via the mobile messaging server such as the Google Messaging Service cloud server system to a Google Android Smart Phone and Smart Watch. The Google Android Smart Phone, acting as proxy for the Smart Watch, may then immediately open a WebSockets connection to the primary server and request the last hour of data or other recent or live information with respect to the data for the input voltage of the UPS. The primary server may then send the last hour of data and graphical-chard data for the input voltage of the UPS, which may then be displayed immediately together with the alert message on the Google Android Smart Watch and Smart Phone. In this way, the user is able to securely, without latency and without accessibility restrictions, receive needed information to allow them to manage their UPS system with the highest efficiency possible.

As another example of a process in accordance with an embodiment of the present invention, the following is a presentation of the operating flow of the method and system if no anomaly is detected by the data-gathering client. A data-gathering client is communicating to an UPS system via a private Ethernet connection from a first Ethernet port on the data-gathering client to an SNMP box which is connected to the UPS system. The data-gathering client continuously polls the SNMP box for UPS system data every 1.5 seconds via the private network connection to receive information with respect to UPS system's security, health and operating condition. With the receipt of each new set of data every 0.5 seconds, the data-gathering client may then scan the system data using an on-board analytics engine for any potential UPS system security, health or operating anomaly. If no anomaly is spotted, a new poll is initiated from the data-gathering client to the SNMP box in order to get the latest set of data from the UPS system. A new scan for anomalies is then done for this new set of data. This process repeats every 1.5 seconds or any other time frame which is acceptable for the user, whether or not anomaly is spotted by the data-gathering client's analytics engine. At the end of each minute, whether or not an anomaly is spotted by the data-gathering client, a WSS connection is opened from the data-gathering client via a second Ethernet port to a primary server. This second Ethernet port on the data-gathering client is normally connected to a corporate Local Area Network (LAN), a corporate Wide Area Network (WAN), a public network such as the Internet or other general access network. Data with respect to the high, low, mean, running mean and standard deviation from the previous minute for each data point monitored on that UPS system. The primary server may then store the information as originally received from the data-gathering client or, it may as an alternative, forward the data to a secondary server for further statistical analysis by opening a WebSocket connection from the primary server to the secondary server.

As another example of this process, a data-gathering client can be in communication with pipeline leak detection or other process control monitoring application. This could include monitoring any water, hydrocarbon, carbon or other product that is transported via a pipeline or manufactured in a process plant. A pipeline leak alert or process control alert can be gathered directly by the data-gathering client or said leak or process control alert may be determined by analytical means from data received from a pipeline leak detection or process control monitoring application by the data-gathering client. If the data-gathering client is receiving alert information only, it may immediately transfer the information via secure push communication connection to a primary server and the server may then immediately transfer information via secure push communication to an end-user client. If the data-gathering client is gathering raw data that must be processed to determine if an alarm is present, it may employ its analytics engine to determine in anomaly exists. If an alarm condition is discovered by the data-gathering client; a secure, push alert message is sent by the data-gathering client to the server and a secure, push alert message is sent by the server to the end-user client.

In absence of the present invention, in order for a message of data to be sent from within a firewall to a remote user, several independent steps would have to be accomplished, each with their own latencies and security issues. The following example illustrates advantages of the present invention. In this example, we shall refer to the common means used by present technology as “existing technology” whereas we shall refer to the present invention as “the present invention.” In our example, we shall consider the need to transmit a highly important piece of data from within a physical facility and a network firewall to a user located outside of the facility and firewall.

Using existing technology, in order to transmit data from inside a facility with a firewall to an end user, several steps are required. First, a data connection, for example, serial connection must be established between a computer and a device being monitored in the facility. Then, using simple, hard-coded high or low alarm points, each data point is compared to the list of high and low alarm points to see if an alarm is present. Should an alarm be present, an e-mail connection would have to be established from the computer to a remote e-mail server. Following this, a message with its contents would be transmitted from the computer to that e-mail server. Finally, in the existing technology, that e-mail server would have to be queried by an end-user's device, which is normally in the order of every 5 minutes for a desktop or 15 minutes for a mobile device, in order to have access to that e-mail message. Unfortunately, in the existing technology, the user would have to pick-up his e-mail message and read it in order to properly respond. In this example of existing technology, failure or delay could occur at any of these numerous steps or within any multiple steps within the process. The failure to deliver and respond to an alert of mission critical nature for minutes or even longer more could be catastrophic. For example, if a message about the health of a patient at a hospital were not properly and quickly relayed, it could endanger the life and health of that patient.

By comparing the present invention with the existing technology, advantages of the present invention will become clear. Although attempts have been made to use HTTP, XML, and other transfer protocol and language methods to increase the speed and reliability of data transfer in such instances, these methods, as was discussed earlier, still suffer from security, latency and accessibility issues. In accordance with embodiments of the present invention, the data-gathering client can immediately establish a secure WebSocket connection from inside a firewall to a primary server. Any failure of such connection can be instantly noted and attempts made to immediately retry other WebSocket or other push technology paths. Once connected, the message of the data-gathering client is immediately transmitted to the primary server for processing arid/or storage. An alert message may be immediately sent to a cloud server messaging service for immediate delivery to the end user to display on their mobile device without the need for them to physically retrieve that data. The end-user client may then immediately establish a WebSocket connection to the primary server to gather additional graphical and other historical data to display on the end user client, all without the user of that end-user client ever having to take any action. Therefore, under the present invention, the information is pushed from the data-gathering client to the primary server to the messaging server to the end-user client instantly and displayed on the end user client resident on a mobile device such as an iPad, with no end-user work being involved. Further, the end-user client may contact the primary server via WebSockets for immediate relay of graphical information with respect to the device, again, all without any work or intervention by the user of the end-user client. In accordance with embodiments of the present invention, this entire process to initially gather data, determine if an alarm is present, and then send and receive the appropriate data happens both securely and virtually instantaneously. Both the WebSocket connections from data-gathering client to server and from server to end-user client have multiple potential routes and instant failure rerouting, ensuring immediately and secure delivery to any mobile or other device. A message sent from the United States with WebSocket that has a destination in Europe has typical completion times in the area of 250 microseconds.

Thus, by pushing the message from the data-gathering client to a server system and then pushing the same or processed data to the end-user client, this multi-push technology solves latency, security and accessibility issues. Data of any kind may be instantly sent from within a firewall to a server and to an end user in virtually any location on any type of device and this could potentially result in the saving of lives, the avoidance of a catastrophe or the reduction of business downtime and associated losses.

In accordance with an embodiment of the present invention, Secure Socket Layer (SSL) communications, may handle security. However, other security solutions may be employed. By securing a connection via SSL or other highly secure and encrypted transmission from the data-gathering client to a primary server and then from a primary server to an MQ server and then from the MQ server to an end-user client, all phases of the communication are secured and the communicated information is kept from potentially threatening parties. This is especially important in health care applications, particularly where the Health Insurance Portability and Accountability Act (HIPAA) is concerned, due to the high degree of security required for the transmittal of information related to a patient. Data security is also extremely important when transmitting information related to the operation of a corporate or government facility and any potential problems or hazards that it may be experiencing.

In accordance with an embodiment of the present invention, the primary server component is handled by the Secure Power Networks UPShield Server System. Such an embodiment maximizes freedom of accessibility and development. The UPShield Server System may be a cloud server system, a virtualized server system, a single server system or any other server system capable of performing the functions of the primary server in the present invention. In cloud server systems comprise multiple physical machines. Each such machine may run virtualization software which allows for multiple virtual servers within each physical server. This, coupled with routing systems that can determine the best location to process a given piece of data, allow cloud server systems to scale quickly as data arrives. Thus, a cloud service provider allows a user remote user to access processing capabilities without the user having to own a dedicated server. However, as one skilled in the art will recognize, any server system, be it one that is a stand-alone server, one that is part of a non-virtualized network, a virtualized server or group of servers, a server cluster or group of cluster servers or other systems can process data and operate in a fashion as described herein.

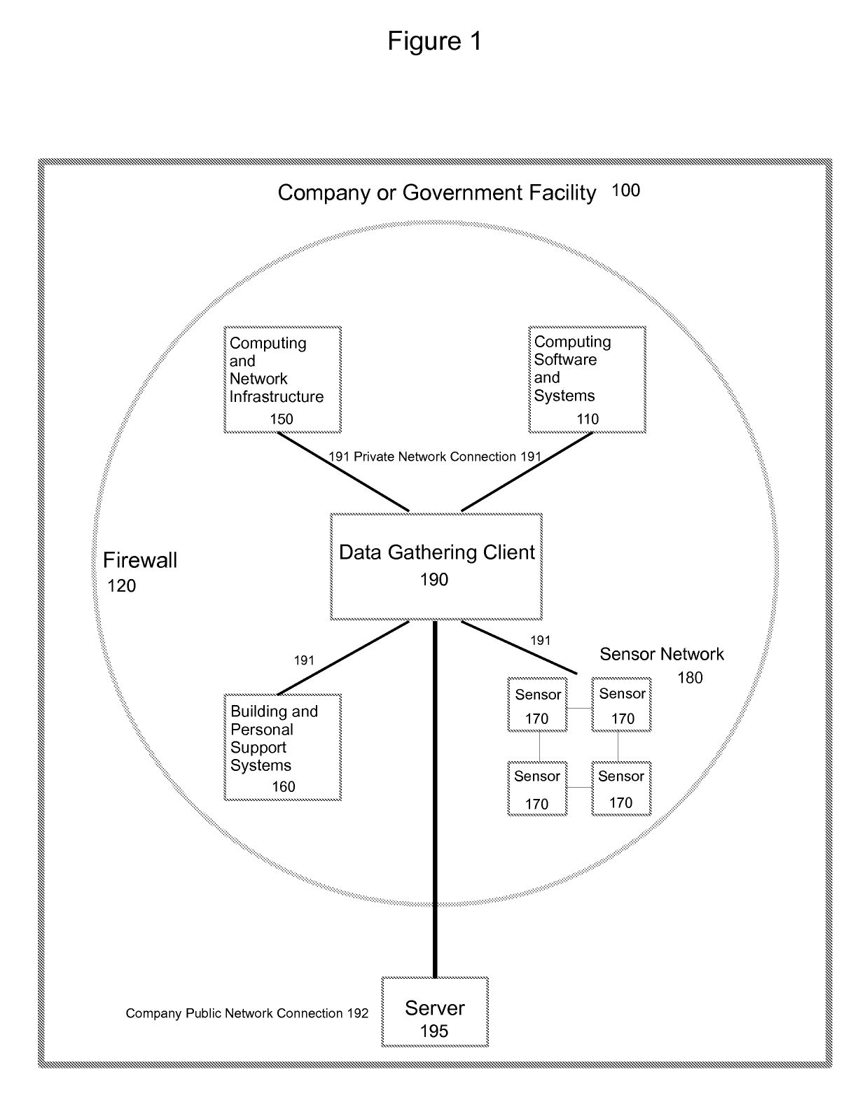

FIG. 1 shows a business or government facility 100 that can include such facilities as office buildings, data centers, manufacturing plants, processing plants, pumping plants, distribution facilities, power grid facilities and extended processing facilities, such as pipelines, among others. Those skilled in the art will understand that there are other such facilities that can be included in this category. In facility 100, computing systems and infrastructure within a physical facility and within a network firewall are shown. Such items as computing-related software and systems 110 may be employed in such a facility, said software and systems 110 may include but are not limited to: servers, standard software, virtualization software, desktop systems, data storage systems, networking equipment, network management systems (NMS) and networking software. In addition, a network security firewall system 120 is typically deployed in the corporate or government facility 100.

In addition, computing and network infrastructure 150 that supports computing-related software and equipment 110 and network security firewall systems 120 may be employed in such sites. Such computing and network infrastructure 150 may include but is not limited to uninterruptible power supply systems (UPSs), power distribution units (PDUs), and power conditioning units, heat vent and air conditioning (HVAC), data center fire protection systems, data center security systems, building management systems (BMS), energy management systems (EMS), video systems, image systems and other related systems. Such systems are often necessary or helpful to support computing and network infrastructure.

In addition to the computing-related software and systems 110, firewall systems 120 and the computing and network infrastructure systems 150; building and personnel support systems 160 are commonly employed in businesses and government facilities, including building HVAC systems, building video systems, image systems, building electrical systems, building fire systems, building security systems, building management systems (BMS), energy management systems (EMS), and other related systems, may be employed at such facility 100. Such systems are often necessary or helpful to support general operations in business or government facilities.

Further, individual sensors 170 may be employed to aid in the management of such sites. Said individual sensors may be stand-alone sensors or part of a sensor network 180. Such individual sensors 170 may include, but are not limited to, analog sensors, digital sensors and proprietary sensors. Sensors from any of these three groups of sensors may include air flow sensors, fluid flow sensors, voltage sensors, current sensors, power sensors, energy sensors, phase angle sensors, security sensors, leak detection sensors, smoke detectors, temperature sensors, light sensors, cameras, motion detectors, pressure sensors, radiation detectors, and other sensors. Said sensor network 180 may be a wireless network, such as a 433 MHz, 900 MHz or Zigbee 2.4 GHz network, an analog signal network, a digital signal network, a serial network, a Bacnet network, an Ethernet network or any standards-based network topology capable of carrying information about any one of the sensors to another device. None of the foregoing mentioned systems or units are meant to limit the scope of the present invention to provide data from any entity within or related to a facility. Those skilled in the art will recognize that many other examples of units and systems common to a corporate or governmental facility may be incorporated into the present invention.

In this business or government facility setting, a data-gathering client 190 may be placed within the facility 100, normally within a network firewall 120 that protects the facility. Computing-related software and equipment 110, network infrastructure systems 150, general building and personnel support systems and infrastructure 160, sensors 170 and sensor networks 180 may be connected via a private and secure device network connection 191 to the data-gathering client 190. The private network 191 may be a secure, standards-based wired network, such as Ethernet, Bacnet, RS-232, RS-485 or it may be a secure, standards-based wireless network, such as Wi-Fi, Bluetooth, Zigbee, or others. Communications protocols such as Simple Network Management Protocol (SNMP), Modbus, Modbus/TCP, Bacnet, ASCII or other standards-based protocols, or non-standards-based protocols, may be supported by the data-gathering client 190 over the secure private network 191.

The data-gathering client, 190, gathers data via the private network connection 191 from the infrastructure devices including computing-related software and equipment 110, network infrastructure systems 150, general building and personnel support systems and infrastructure 160, sensors 170 and sensor networks 180. The data-gathering client 190 then analyzes data received from such devices via a statistics engine to discern if any operational or other security anomalies are present with any device to which it is connected. If an anomaly is discovered, the data-gathering client, 190, immediately pushes data with respect to that anomaly to the server, 195, via a company, government network or public network, 192, such as a local area network (LAN), wide area network (WAN), storage area network (SAN) or other company or government network or a public network such as the Internet. In essence, while each private network connection 191 has no ability for an outside individual to gain access, any corporate, government or public data network has multiple individuals that can join in this network. In this sense, every network that is not a private network 191 is a type of public network 192. The data-gathering client 190 may also push data to the server 195 through the public network 192 on a periodic basis, for example, every minute, with respect to summary data about the device or devices that it is monitoring.

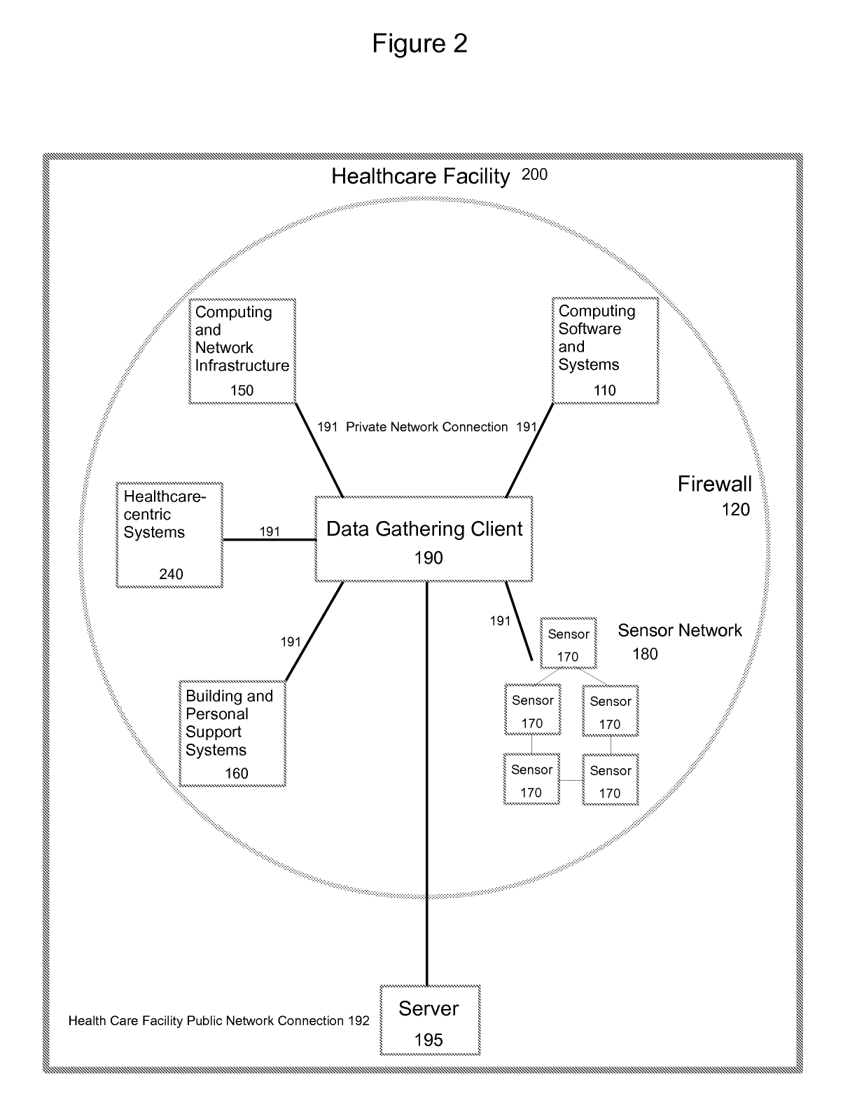

FIG. 2 shows a healthcare facility 200 such as a hospital, outpatient surgery center, medical imaging center, doctor's office, immediate care facility, institutional facility or other healthcare related facility. Those skilled in the art will realize that other such facilities can be included in this category. Healthcare facility 200 is shown to include computing-related systems and software 110 within a physical facility and within a network firewall 120. In addition to the computing-related software and systems 110, healthcare facilities 200 typically employ computing and network infrastructure systems 150, general building and personnel support systems and infrastructure 160, sensors 170 and sensor networks 180. In addition, healthcare facilities 200 employ healthcare-centric monitoring systems 220. Such healthcare-centric monitoring systems 220 may include but not be limited to patient monitoring systems, environmental monitoring systems, nurse station systems, doctor support systems, personnel management systems, patient records systems, visitor support systems, laboratory systems and other related systems. None of the foregoing mentioned systems or units are meant to limit the scope of the present invention to provide data from any item within or related to a facility. Those skilled in the art will recognize that many other examples of units and systems common to a corporate or governmental facility or healthcare facility may be incorporated into the present invention.

In the healthcare facility 200, a data-gathering client 190 may be placed within the facility, normally within a network firewall 120 that protects the facility. The computing-related software and equipment 110 and the patient monitoring systems 220 as well as the computing and network infrastructure systems 150 and general building and personnel support systems 160, the sensors 170 and sensor network 180 may be connected via a private network connection, 191, to a data-gathering client 190. The private network may be any one of a list that includes a secure wired connection such as Ethernet, Bacnet, RS-232, RS-485 or it may be a secure wireless network such as Wi-Fi, Bluetooth, Zigbee, or others. Preferably, the private device network connection, 191, is a private connection between the data-gathering client device 190 and the device being monitored using communications protocols such as Simple Network Management Protocol (SNMP), Modbus, Modbus/TCP, Bacnet, ASCII or other standards-based protocols. Non-standards-based protocols, may also be supported by the data-gathering client 190. The data-gathering client 190 regularly polls or receives pushed data via the private network connection 191 from any of the computing-related software and equipment 110, the firewall systems 120, the healthcare-centric monitoring systems 220, the network infrastructure systems 150, general building and personnel support systems and infrastructure 160, and the sensors 170 and sensor network 180. The data-gathering client 190 then analyzes data received from such devices via a statistics engine to discern if any operational or other anomalies are present with one or more devices. If an anomaly is discovered, the data-gathering client, 190, immediately pushes data with respect to that anomaly to the server, 195, via a company, government network or public network 192, such as a Local Area Network (LAN), Wide Area Network (WAN), Storage Area Network (SAN), other company-based network or the Internet. The data-gathering client 190 may also push data to the server, 195, over the company, government network or the Internet, 192, on a periodic basis, for example, every minute, with respect to summary data about the device or devices that it is monitoring, as gathered and analyzed.

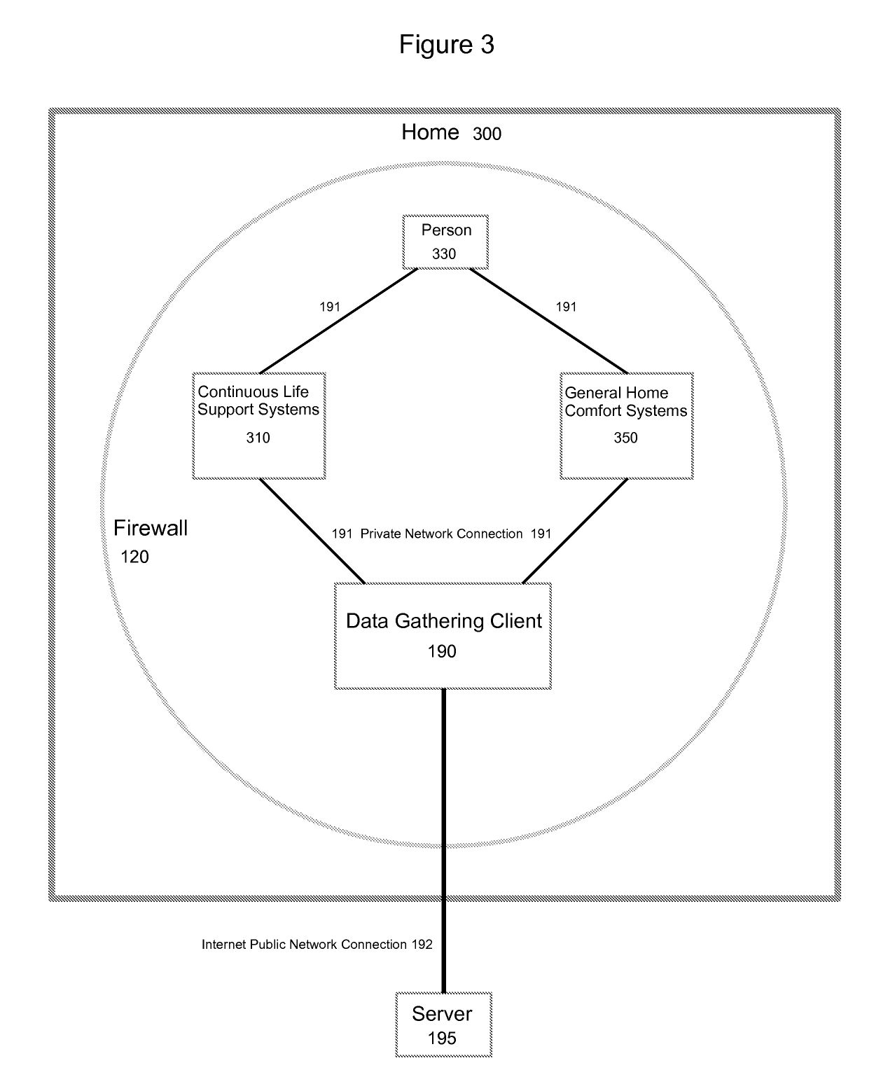

FIG. 3 shows a residential setting 300 such as a house, condominium, apartment, assisted living facility or nursing home. As our world's population ages, occupants of homes may be elderly or may be other persons who are able to live in a home 300 but who may have physical or emotional needs that require continuous life support/monitoring systems 310. Such life support monitoring systems may include heart monitoring systems, blood pressure monitoring systems, pulse monitoring systems, temperature monitoring systems, blood analysis systems, respiration monitoring systems, cell monitoring systems and other related systems. Other monitoring systems can be provided, such as stand-alone sensors, a sensor network, or monitoring systems that provide an ability for a resident 330 to request emergency or non-emergency assistance.

In addition, general home and personal comfort systems 350 may be employed in the residential setting. These general home and comfort systems 350 may include HVAC systems, video systems, and audiovisual systems, imaging systems, thermostat systems, home automation systems, security systems, electrical systems and other related systems. None of the foregoing mentioned systems or units are meant to limit the scope of the present invention to provide data from any item within or related to a facility. Those skilled in the art will recognize that many other examples of units and systems common to a home may be incorporated into the present invention.

In a home facility such as the setting in 300, a data-gathering client 190 may be placed within the home 300, and may be within a network firewall 120 that protects the network within the facility. The continuous life support equipment and systems 310 and the general home comfort systems 350 supporting the persons 330 in that home, may be connected via a private standards-based network, 191, such as secure wired networks that may include Ethernet, Bacnet, RS-232, RS-485 or secure wireless network such as Wi-Fi, Zigbee, Bluetooth, or others to a data-gathering client device 190. Communications protocols such as Simple Network Management Protocol (SNMP), Modbus, Modbus/TCP, Bacnet, ASCII or other standards-based protocols, or non-standards-based protocols, may be supported by the data-gathering client 190. The data-gathering client 190 may regularly poll or receive pushed data over the private network 191 from any of the continuous life support/monitoring systems 310 and the general home comfort systems 350 supporting the persons 330 in that home 300. The data-gathering client 190 may then process the data it receives or send all or part of that data by pushing data to a server 195, over a company, government or public network connection 192, such as an Internet connection.

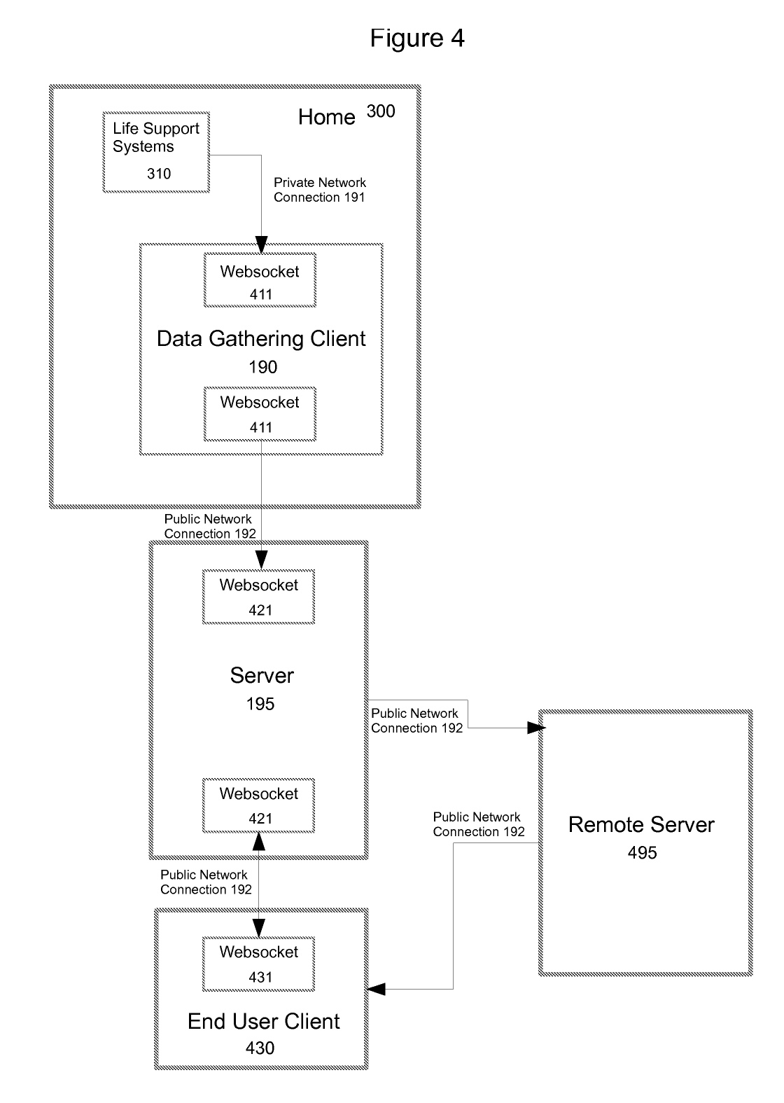

Turning now to FIG. 4, we see a diagram in accordance with an embodiment of the present invention in a home setting 300. As this figure shows, the data-gathering client 190 receives information over a private network connection 191 from life support systems 310 within a home 300. The data gathering client 190 is appropriately configured to implement WebSocket communications between itself and a server 195 via a public network connection 192. The information from the system 310 may be received by the data-gathering client 190 through the private network connection 191 which may be a secure wired connection such as a direct point-to-point Ethernet connection line or secure wireless connection such as secure point-to-point WiFi, although it will be apparent that this information can be obtained by the data gathering client 190 in other manners via the private network connection 191. The data-gathering client 190 then establishes a WebSocket 411 connection with a WebSocket 421 on a server 195 and pushes data to that server 195 via a public network connection such as the Internet. The server 195 is also appropriately configured to implement and thus, respond to WebSocket communications. The data-gathering client 190 with the WebSocket capabilities via 411 may be an embedded system within an appliance such as a blood pressure device, a stand-alone embedded system, a serial server, a PC, agent software running on a PC, an agent software running on a server, or any other type of device that may communicate with an infrastructure or software device via a standards-based network. It may also be embedded into other devices with which it communicates, such as an HVAC system or medical device. That standards based private network 191 may be any one of Ethernet, Bacnet, Wi-Fi, Zigbee, Bluetooth, other wireless, RS-232, RS-485, IC2, analog, digital or any other type of standards-based network with which the data-gathering client 190 may communicate via a private network 191.

The server 195 may be a cloud-based server, an individual server, a clustered server, a bank of servers, or any other type of device capable of receiving transmission from the data-gathering client 190 using a WebSocket connection 411 via Ethernet or another public network topology 192. The server 195 receives its data through its own WebSocket 421 on which it listens for an incoming WebSocket connection from a data-gathering client 190 and its WebSocket 411 via the public network 192. Once the server 195 has received data on its WebSocket 421 from the data-gathering client 190 and its WebSocket 411, and once the server 195 has authenticated the sending data-gathering client 195 and its WebSocket 411, the server 195, may then transmit a message to a remote server 495 in order for that remote server 495, such as a wireless messaging server, to act as a transmission agent between the server 195 and the end-user client 430. The transmission from the remote server 495 to the end-user client 430 may preferably be via a secure, wireless public network connection for immediate display on the end-user client 430.

The end-user client 430 has, in turn, its own WebSocket 431, through which the end-user client 430 may receive the data. The end user client may also receive the data from the remote server 495 through a non WebSocket connection. The end-user client 430 may display information sent from the server 195 to the remote server 495 in order for the user to make use of the data. The end-user client 430 may then establish a secure connect to the server 195 via a WebSocket 421 for additional live or updated data with respect to the data message via its own WebSocket 431 through a public network 192. The end-user client may be any from a group including a desktop, a laptop, a tablet computer, a mobile phone, a personal digital assistant, a wrist-worn device or any other device that is capable of using WebSocket to gather data to be displayed.

The remote server 495 may perform a number of duties. It may, for example, further analyze data as sent from the server 195. It may, as another option, simply store data that it receives from the server 195. The remote server 495, in another option, may store and forward data from the server 195 to an end-user client 430. The remote server may, in yet another option, may simply forward data to the end-user client 430.

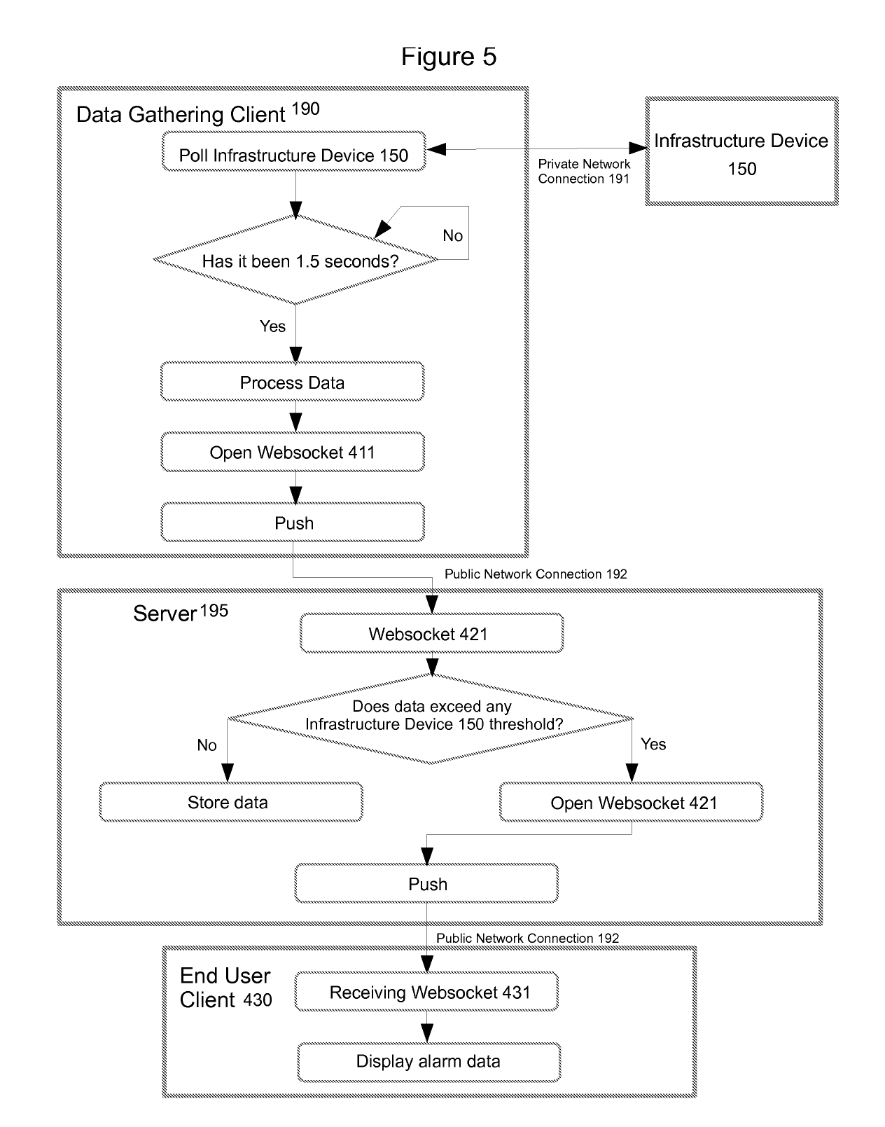

Now turning to FIG. 5, we can view a flow chart of one particular embodiment of the invention as one particular example of the present invention being used at a corporate application 100 to securely manage an infrastructure device 150. As an example of the embodiment this entire transaction, the data-gathering client 190 may be connected to an infrastructure device 150 and the data-gathering client 190 may poll the infrastructure device every 1.5 seconds for its latest data set. Rather than process information to look for anomalies by itself, the data-gathering client 190 may open a secure WebSocket connection 411 between itself and the WebSocket 421 on the Server 195. The data-gathering client 190 may then push all or a portion of that data to the server 195 via a WebSocket connection. The server 195 may then process the data and immediately via an analytics engine to look for anomalies. The server 195 may then identify a parameter from the data received about the infrastructure device 150, that is out of it normal tolerance and the server 195 may, then immediately open a WebSocket connection from itself 421 to the WebSocket 431 of the end-user client 430 and push data to that end-user client 430 thus instantly notifying the user of the out of tolerance condition of the infrastructure device 150.

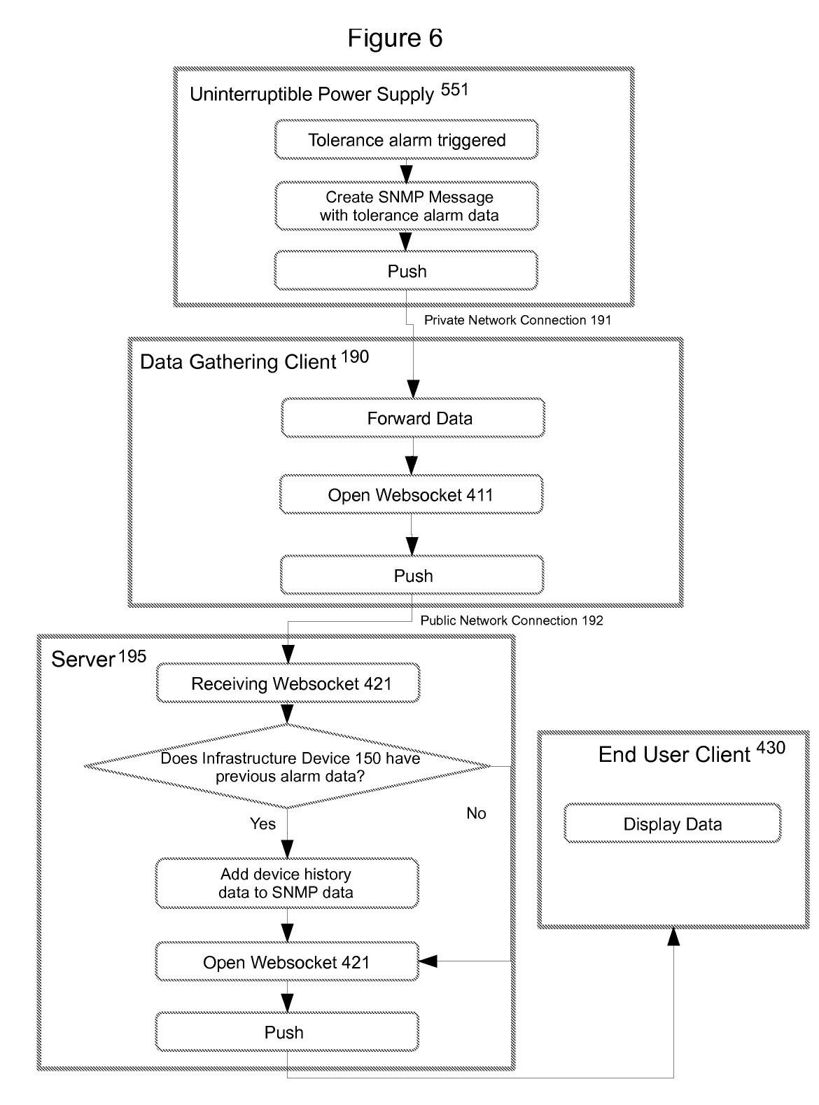

In another example of the embodiment of the invention where software of firmware resident or attached to an Uninterruptible Power Supply 551 computes alarm decisions is shown in FIG. 6. Here, the data client 190 may be connected to an infrastructure device 150 that, in turn, communicates to the data-gathering client 190 via its own data push. For example, an uninterruptible power supply (UPS) 551 may be a part of the system and may include a simple network management protocol (SNMP) trap alarm card that determined system anomalies and pushes information to the connected device when an anomaly is spotted. When the uninterruptible power supply 551 is in an out of tolerance condition within its circuitry, the unit can immediately push an SNMP alert message to the data-gathering client 190 and the data-gathering client 190 may, in turn, push the alarm information to the server 195 by using WebSocket connections 411 and 421. The server 195 may, in turn push data to the end-user client 430 using WebSocket connections 421 and 431. The server 195 may simply forward the SNMP trap as received from the data-gathering client 190 or it may process and/or add other data to the SNMP trap data. The server 195 may, for example, retrieve historical information with respect to the UPS 551 and send that data to the end-user client 430 as a part of a data stream or data packets sent via WebSocket 421 and 431. All of these transmissions of data from data-gathering client 190 to server 195 and to end-user client 430 is via WebSocket connections to insure the maximum speed, reliability, security and accessibility of the data.

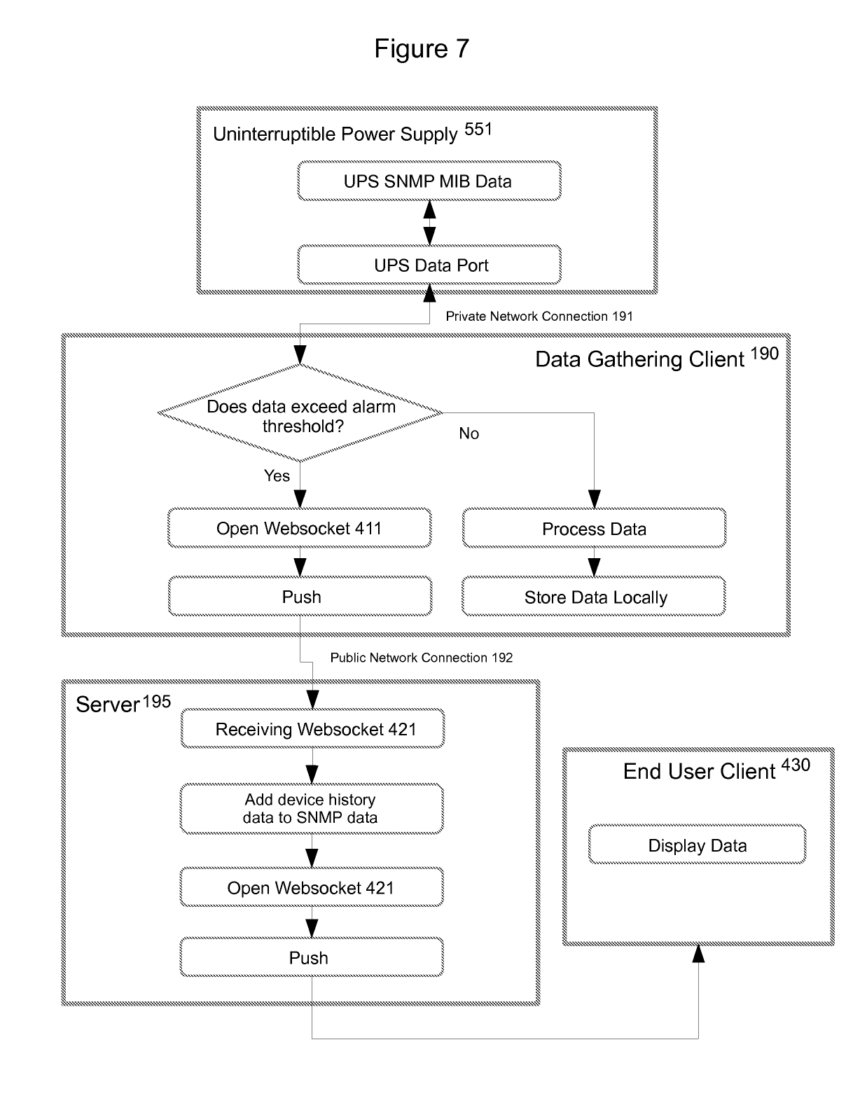

As another example of the embodiment of the invention, FIG. 7 shows a system where the data-gathering client polls 190 data from the SNMP Management Information Base (MIB) with respect to a UPS 551 on a periodic basis, such as every 0.5 seconds. The data-gathering client computes may then autonomously compute alarm decisions from this raw MIB data as shown. The data-gathering client 190 may have analytical function capabilities to process and analyze data as it's received from the infrastructure device 150 such as a UPS 551. In that case, rather than relying on the server 195 to process the data, the data-gathering client 190 may poll data and statistically determine that the UPS 551 is operating out of 3.5 standard deviations for a particular data point which it may determined to be out of tolerance. The data-gathering client may then immediately open a WebSocket connection 411 to the server's WebSocket 421 and instantly forward all necessary data. In this instance, the server 195 may immediately forward the data received to the end-user client 430 by opening a WebSocket connection between itself 421 and the end user WebSocket 431. The server 195 may then send all data received from the data-gathering client 190 and may add device history data to the data received from the UPS system's SNMP data. All of this data may be sent to the end-user client 430 to allow the end-user client device 430 to display all appropriate information concerning the UPS system 551 and its out of tolerance condition.

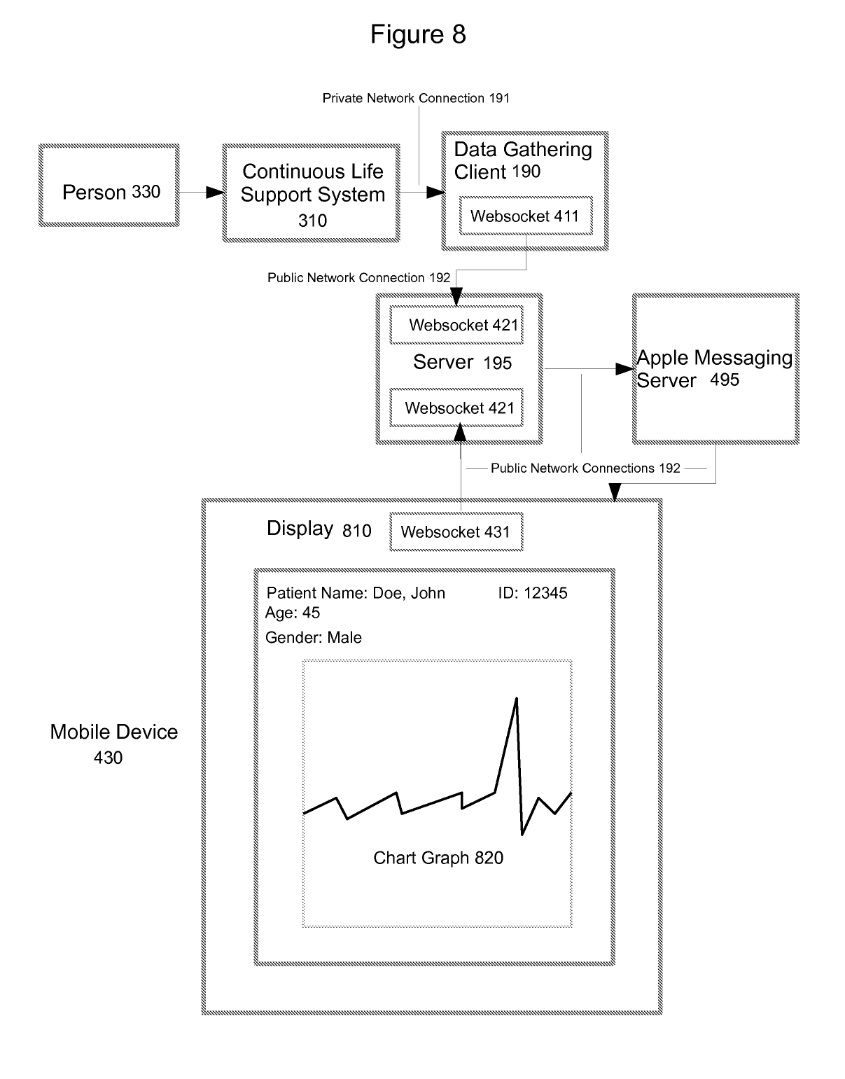

Now turning to FIG. 8, we see data being gathered from a continuous life support system 310 via a data-gathering client 190 and being sent first through the server 195 and then a secondary messaging server 495, then finally on the an end-user client 430 for display. The data displayed may include any type of data sent gathering from the continuous life support system. Thus, there are no limits on the type of device with which the data-gathering client 195 may communicate. FIG. 8 represents the data display on an end-user client 430. The end-user client 430 may represent a display on a mobile device such as an Android device, an iPhone or iPod. The end-user client 430 shown in FIG. 8 may also represent a display on a traditional computer system such as a laptop or PC system. The end-user client shown in FIG. 8 may also represent a display on a console system such as a home automation system, a building management system, or a network management system. Those skilled in the art would understand that the end-user client 430 may be any device that is capable of consummating a WebSocket or other network transaction and displaying the data received through that web socket might be used to display the data from the server 195.

In 810, we see a display on a mobile device. That display 810 shows the data of an abnormal condition from a person 330 on a continuous life support system 310. In this case, the person 330 is showing an abnormal pulse rate on graph 820 as opposed the normal pulse rate of this person 330. In this example the data-gathering client 190 processes data from the life support system 330 and immediately determined that its present data was outside normal parameters. The data-gathering client 190 immediately initiated a WebSocket 411 connection to the server's web socket 421 and the server 195 immediately passes that message of the out of an abnormal condition for the person 330 to the Apple Messaging Server 495 as a secondary server. The Apple Messaging Server 495, in turn, immediately sends this information over a secure connection through a public network connection to the mobile device 430 through the Apple Messaging Service. Because the server 195, in this instance, also maintains a database of historical information about this patient 330 and their normal parameters, including their pulse rate as received from the continuous life support system 310, the end-user client mobile device 430 may contact the server 195 via its own secure WSS WebSocket 431 through the server's secure WSS WebSocket 421 for a live, up-to-the-second data about the historical pulse rate from the patient 330. This data immediately populates a chart graph 820 on the end-user client 430 thus allowing for the instant understanding by the end user of the issue surrounding the person 330. All of these transactions between the server 195, messaging server 495 and the end-user client mobile device 430 are transacted via one or more public networks 192.

Thus, in the present instance, the person who is using the end-user client device 430, can see all present and historical information related to the pulse rate of the patient 330 on the graph 820, securely over a public network 192, such as the Internet, thus enabling them to make an informed and immediate decision about whether the patient 330 may need additional medication or other immediate treatment. Because of the speed and security of the multi-push communication established in the present invention using WebSockets 411, 421 and 431 coupled with ability to provide historical information from the server 195 together with real time information from the data-gathering client 190 all displayed on the end-user client device 430, lives could be saved that might otherwise have been lost. In addition, business operations from company and government operations within a facility 100 or 200 may be saved from interruption by the combination of instant real-time and historical information displayed to the appropriate person on their end user device 430 in a similar fashion to that shown in FIG. 8.

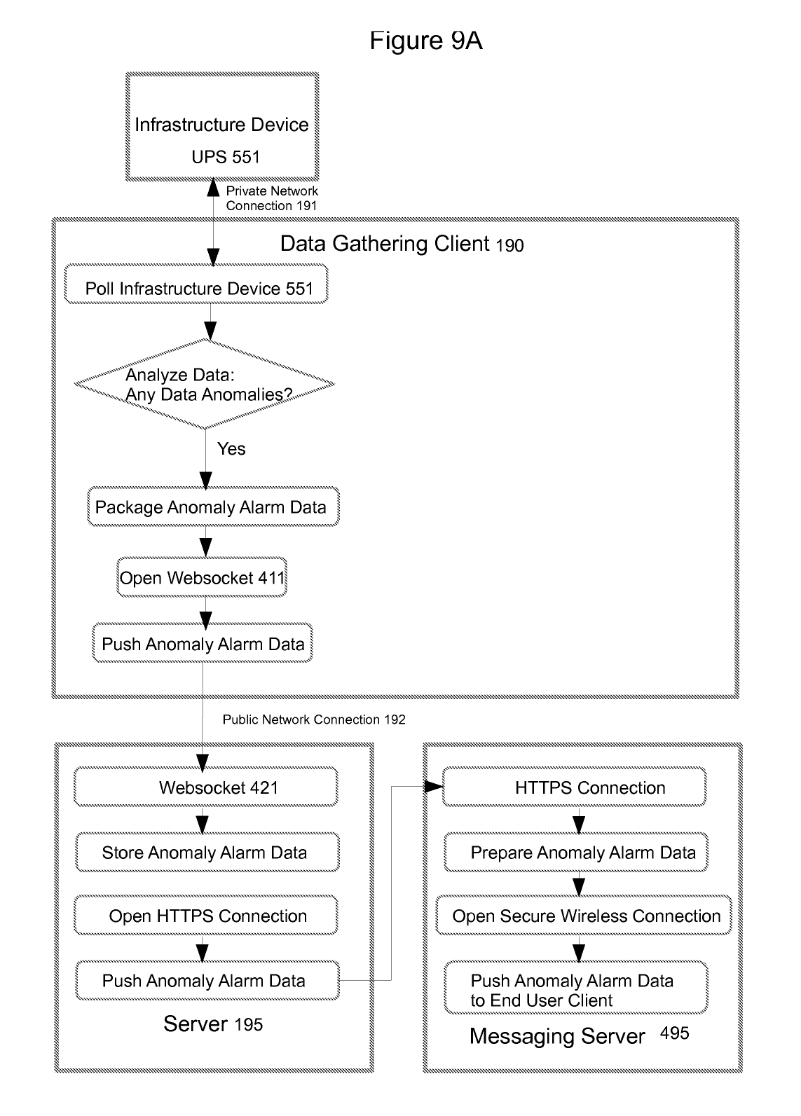

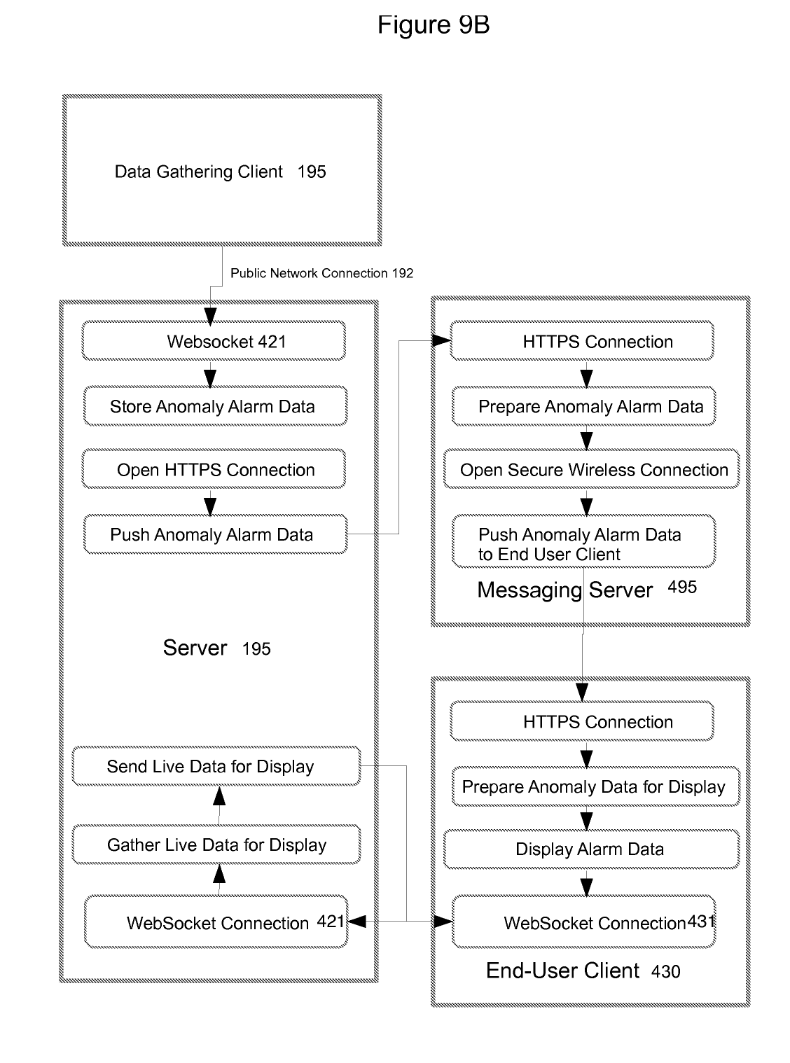

Turning now to FIG. 9A, we see an example of the present invention polling a infrastructure device, in this case a UPS system 551. In this case, the data-gathering client 190 discovers an anomaly in the operations of either the cyber, physical or operational security of the UPS 551. FIGS. 9A and 9B follow through the progression of actions of the present invention from inception to the display of the alarm information on the end-user client 430. As we examine FIG. 9A, here the data-gathering client polls the UPS system 551 via a secure private point-to-point network connection 191, such as a private Ethernet connection. The data-gathering client may poll the UPS unit 551 continuously as rapidly as the UPS unit 551 will allow. Once the data is received by the data-gathering client 190 from the UPS unit 551, the data is analyzed by a statistics engine to determine if any data point is out of its normal statistical range, such as being greater than 3.5 standard deviations from the running mean. If a data point is out of tolerance in respect to its statistical normal range, the data-gathering client 190 immediately packages the data from the data point that is out of tolerance and opens WebSocket 411 in order to push the alarm information of the out-of-tolerance condition to the server 195.

The server 195 receives the data from the data-gathering client 195 on its WebSocket 421 and may immediately stores information about the data point anomaly. It then may immediately open an HTTPS connection to a messaging server 495, in order to transmit the message to a end-user client mobile device 430. The server 195 pushes the alarm information via HTTPS to the messaging server 495. It is clear to those with an understanding of the art that any secure protocol used by a messaging server may be used in place of HTTPS. Once received by the messaging server 495, the alarm data is then packaged for transmission on a wireless connection to the end-user client 430 via a push connection over a secure, open standards wireless connection. Again, those with skill in the art will understand that any wireless or even wire line system with the ability to securely deliver this alarm message data may be employed.

Now turning to FIG. 9B, we see all of the relevant portions of FIG. 9A included and we now see the transmission from the messaging server 495 to the end-user client 430 via a secure wireless HTTPS connection. Once the end-user client 430 receives the alarm data via the wireless connection, the data with respect to the alarm anomaly is prepared for display on the end-user client 430 and the data is then displayed. Once initially displayed, the end-user client 430 may open a secure WebSocket connection 431 to the server 195 and a WebSocket 421 in order to receive via bidirectional communication, any live or historical information as may be necessary. In this way, all information necessary to make quick and proper decisions with respect to critical events are transacted without the need for an individual to connect a server or job site but, rather, all of the information necessary to make proper decisions are simply put on their mobile or other end-user client device 430 exactly when they need it.

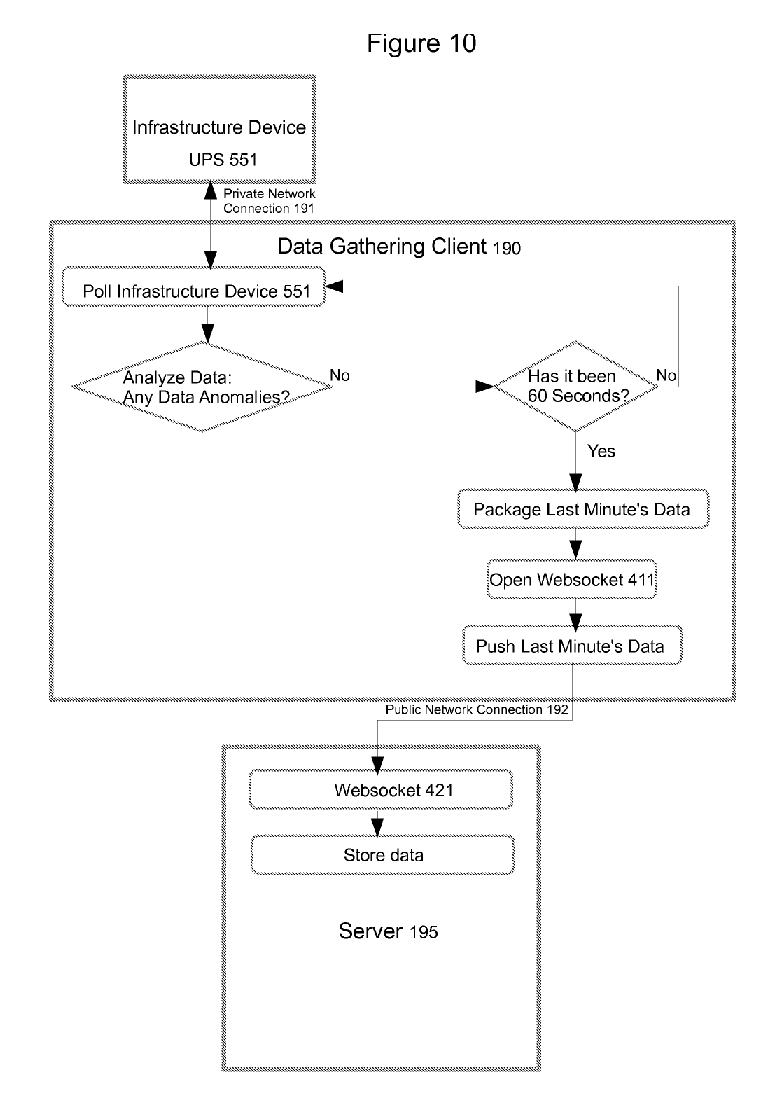

Turning finally to FIG. 10, here we see the case where a data-gathering client 190 that is similarly configured as in FIGS. 9A and 9B does not detect an anomaly with the device that it is monitoring, a UPS system 551. In this case, the data-gathering client 190 continues to poll the UPS 551 until the end of each minute of time. At the end of that time, the data-gathering client 190 opens a WebSocket connection 411 to the server 195 and its WebSocket 421. The data-gathering client then securely pushes the last minute's data gathered and processed from the UPS 551 to the server 195. The server 195, in turn may store that data in a database, such as a MySQL data base for future use as desired.

The server 195 may store all data that is sent to it from a data-gathering client 190 or, a server 195 may store only selected data points or sets from a data-gathering client 190. The server 195 may also connect to an external server, cloud server or cloud storage system or server analysis systems. Such use of external systems could be connected using WebSocket or another connection that could be used in push communications such as HTTP using SSL, push communications within a client or server system or any other authorized means available.

In the case where the data-gathering client 190 pushes data to the server 195 periodically, such as every minute, the data-gathering client 190 may also store historical data from either the past 1.5 seconds, or the past minute, or the past hour or any section of time that may be desired and possible. The data-gathering client may still retain data for any period of time in its own memory, for example the past 1.5 seconds, the past minute, or the past hour or any section of time that may be desired and possible. WebSocket connections do not need to be made but the data-gathering client may be configured to accept other connections such as a secure HTTPS connection.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. In a standards-based network, a communication system consisting of at least one monitored device which can transmit data with respect to its condition, one or more data-gathering clients, one or more servers and one or more end-user clients, wherein the at least one data-gathering client receives the data from the monitored device over a private network connection and the data-gathering client opens a push-communications connection between itself and the server and transfers the data to the server over a standards-based network and, wherein, the server opens a push-communications connection between itself and the end user client over a standards-based network wherein the end user client displays data from the server with respect to data which originated from the data gathering client with respect to the monitored device.

2. The private network per claim 1 where the private network is one or more from a group that includes at least one of: Ethernet, Bacnet, WiFi, RS-232, RS-485, an analog signal network, a digital signal network, Zigbee, 900 MHz wireless and 433 MHz wireless.

3. The standards-based network per claim 1 where the standard is one or more from a group that includes at least one of: Ethernet, Bacnet, WiFi, Zigbee, 900 MHz wireless and 433 MHz wireless.

4. The monitored device from claim 1 which may be any object from a group that includes: computing-related software, computing-related hardware, computing and network Infrastructure, general building and personnel support systems and infrastructure, Individual sensors, a sensor network, continuous monitoring systems, continuous life support systems and home and comfort systems.

5. The general building and personnel support systems and infrastructure from claim 4 which may be any object from a group that includes: uninterruptible power supply, power distribution unit, generator and heating ventilation air conditioning.

6. The push communications connection per claim 1 wherein the push connections are effected through WebSockets.

7. The push communications connection per claim 1 wherein the push connections are persistent

8. The push communications connection per claim 1 wherein the push connections are not persistent

9. The end user client per claim 1 wherein the end user client is a mobile device

10. The end user client per claim 1 wherein the end user client is any from a group that includes a network management system, a fire protection system, a building management system, an energy management system, a general building personnel and support system, a healthcare-centric monitoring system or a continuous life support/monitoring system.

11. In a network, a method of communication wherein a device can communicate information with respect to its condition to a data-gathering client over a private network connection and, wherein the data-gathering client can receive the data and then transmit the data or other data with respect to the device to one or more servers via a push-communications connection over a standards-based network from the data gathering client to the one or more servers and at least one server can transmit information with respect to the device to an end user client over a standards-based network.

12. The private network per claim 11 where the private network is one or more from a group that includes at least one of: Ethernet, Bacnet, WiFi, RS-232, RS-485, an analog signal network, a digital signal network, Zigbee, 900 MHz wireless and 433 MHz wireless.

13. The standards-based network per claim 1 where the standard is one or more from a group that includes at least one of: Ethernet, Bacnet, WiFi, Zigbee, 900 MHz wireless and 433 MHz wireless.

14. The device from claim 11 which may be any object from a group that includes: computing-related software, computing-related hardware, computing and network Infrastructure, general building and personnel support systems and infrastructure, Individual sensors, a sensor network, continuous monitoring systems, continuous life support systems and home and comfort systems.

14. The push communications connection per claim 10 wherein the push connections are effected through WebSocket.

15. The push communications connection per claim 10 wherein the push connections are persistent

16. The push communications connection per claim 10 wherein the push connections are not persistent

17. The end user client per claim 10 wherein the end user client is a mobile device

18. The end user client per claim 10 wherein the end user client is a PC

19. The end user client per claim 10 wherein the end user client is any from a group that includes a network management system, a fire protection system, a building management system, an energy management system, a general building personnel and support system, a healthcare-centric monitoring system or a continuous life support/monitoring system. And, wherein the server receives the data and transmits the data or other data with respect to the target object to a remote network enabled device by opening a WebSocket connection between itself and the remote network enabled device.

20. The standards based network per claim 10 where the standard is one or more from a group that includes at least one of: Ethernet, Bacnet, Wi-Fi, RS-232, RS-485, an analog signal network, a digital signal network, Zigbee, 900 MHz wireless and 433 MHz wireless.

21. The target object from claim 10 which may be any object from a group that includes: computing-related software and equipment, computing and network Infrastructure, general building and personnel support systems and infrastructure, Individual sensors, a sensor network, continuous monitoring systems, continuous life support systems and home and comfort systems
